(19) United States
(12) Patent Application Publication
(10) Pub. No.: US 2024/0194419 A1
(43) Pub. Date: Jun. 13, 2024

(54) INTEGRATION OF ENERGY HARVESTING ELEMENTS WITH MECHANICAL USER INTERFACES

(71) Applicant: Ambient Photonics, Inc., Scotts Valley, CA (US)

(72) Inventors: Joshua A. Wright, Scotts Valley, CA (US); Colin Owen, Scotts Valley, CA (US); Bates Marshall, Scotts Valley, CA (US)

(21) Appl. No.: 18/533,001

(22) Filed: Dec. 7, 2023

Related U.S. Application Data
(60) Provisional application No. 63/386,484, filed on Dec. 7, 2022.

(51) Int. Cl. H01G 9/20; G06F 3/02; H02S 10/20; H02S 10/40

(52) U.S. Cl. CPC H01G 9/2077; G06F 3/0202; H01G 9/2059; H02S 10/20; H02S 10/40

(57) ABSTRACT

Mechanical user interfaces having a translucent user interface with an integrated photovoltaic element.

### CROSS REFERENCES TO RELATED APPLICATIONS

This application claims benefit of and priority to U.S. Provisional Application 63/386,484, titled “INTEGRATION OF ENERGY HARVESTING ELEMENTS WITH MECHANICAL USER INTERFACES,” and filed on Dec. 7, 2022, which is incorporated by reference herein in its entirety and for all purposes.

### FIELD

Certain aspects generally pertain to user interfaces and, more specifically, to mechanical user interfaces that integrate at least one energy harvesting element such as a photovoltaic cell.

### BACKGROUND

Electronic devices can consume a significant amount of power. Many electronic devices, especially those that are portable, rely on battery power. Traditional batteries are disposable devices that contain harmful chemicals. Rechargeable batteries might be considered an environmentally friendlier alternative in certain respects, and some electronic devices have an integrated rechargeable battery that is not user replaceable. The rechargeable battery may be charged through a wired interface or may be charged wirelessly. A photovoltaic cell is an example of an energy harvesting element that can be used as a fully integrated charging solution that does not rely on an external charging device.

### SUMMARY

Certain embodiments pertain to electronic devices. In some cases, an electronic device has a device housing having a front side, a photovoltaic cell housed within the device housing. The photovoltaic cell is configured to receive ambient light and generate electric power to power the electronic device. The electronic device also has a translucent user interface (UI) component provided at the front side of the device housing. The translucent UI component is configured to accept user input (e.g., a pressure load applied) to the electronic device via physical contact with the translucent UI component and configured to transmit ambient light to the photovoltaic cell. In one case, the electronic device includes one or more pressure redistribution elements configured to redistribute a pressure load away from the photovoltaic cell.

Certain embodiments pertain to an electronic device including a housing having a frontside and a backside. The electronic device also includes a photovoltaic element within the housing and a translucent user interface (UI) component at the front side of the housing. The translucent user UI component is configured to receive a first pressure and to pass ambient light from an exterior environment to a first light facing surface of the photovoltaic element. In some cases, the electronic device includes one or more pressure redistribution elements configured to substantially redistribute the first pressure away from the photovoltaic element and transfer at least a portion of the first pressure to at least one switch (e.g. a center switch) of a plurality of switches.

Certain embodiments pertain to an electronic device including a housing having a frontside and a backside. The electronic device also includes a photovoltaic element including a least one bifacial photovoltaic cell within the housing. The electronic device also includes a translucent user interface (UI) component at the front side of the housing. The translucent user UI component is configured to receive a first pressure and to pass ambient light from an exterior environment to a first light facing surface of the photovoltaic element. In some cases, the backside of the housing includes a translucent window configured to pass ambient light received from the exterior environment. In one of these cases, the electronic device also includes one or more pressure redistribution elements configured to substantially redistribute the first pressure away from the photovoltaic element and transfer at least a portion of the first pressure to an offset center switch.

Certain embodiments pertain to an energy harvesting system including a photovoltaic element configured to generate energy from ambient light received through a translucent user interface component in an electronic device. The energy harvesting system also includes one or more energy storage elements, a power management controller configured to receive energy generated by the photovoltaic element and store energy to the one or more energy storage elements, and a load system configured to receive energy from the power management controller and use the energy to perform one or more functions of the electronic device.

These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Illustrative embodiments are described in detail below with reference to the following figures.

FIG. 1A depicts an isometric drawing of an example of an electronic device with a mechanical user interface having a translucent user interface component, according to embodiments.

FIG. 1B depicts another isometric drawing of the remote control electronic device shown in FIG. 1A.

FIG. 2A depicts an isometric drawing of an example of an electronic device with a mechanical user interface having a translucent user interface component and a translucent window in a backside of the device housing, according to embodiments.

FIG. 2B depicts another isometric drawing of the remote control electronic device shown in FIG. 2A.

FIG. 3 depicts a cross-sectional view of an example of components of a mechanical user interface in the form of a directional pad (D-pad), according to an embodiment.

FIG. 4 depicts the cross-sectional view in FIG. 3 with a pressure applied to the bezel at cardinal position North (N).

FIG. 5 depicts the cross-sectional view in FIG. 3 with a pressure applied to the bezel at cardinal position South (S).

FIG. 6 depicts an exploded view of components of a remote control electronic device, according to an embodiment.

FIG. 7 depicts a cross-sectional view of an example of components of a mechanical user interface in the form of a D-pad with a bifacial photovoltaic element, according to an embodiment.

FIG. 8 depicts the cross-sectional view in FIG. 7 with a pressure applied to the bezel at cardinal position North (N).

FIG. 9 depicts the cross-sectional view in FIG. 7 with a pressure applied to the bezel at cardinal position South (S).

FIG. 10 depicts an exploded view of components of a remote control electronic device, according to an embodiment.

FIG. 11 is a simplified block diagram of an energy harvesting system, according to embodiments.

FIG. 12 is a simplified block diagram depicting some exemplary operations of energy harvesting system during a full light condition, a partial light condition, and a no light condition, according to an embodiment.

FIG. 13 is a schematic diagram depicting a cross-section of an example of the general architecture of a dye-sensitized photovoltaic cell according to an embodiment.

FIG. 14 is a schematic diagram depicting a cross-section of an example of architecture of a bifacial photovoltaic cell according to an embodiment.

FIG. 15 is a schematic diagram depicting a cross-section of an example of architecture of a bifacial photovoltaic cell according to an embodiment.

The figures and components therein may not be drawn to scale. Various components of the figures described herein may not be drawn to scale.

### DETAILED DESCRIPTION

Provided herein are mechanical user interfaces having integrated energy harvesting elements. Also provided are electronic devices that include these mechanical user interfaces. An energy harvesting element may include a photovoltaic cell configured to generate electricity from ambient light via the photoelectric effect. The mechanical user interfaces include a translucent user interface (UI) component that is configured to receive user input such as, e.g., a pressure via physical contact with the translucent UI component. The translucent UI component allows transmission of light from the exterior environment to the photovoltaic cell. Some examples of electronic devices that can include such mechanical user interfaces are remote control devices, computer peripherals, and smart home devices.

Certain mechanical user interfaces described herein allow electronic devices to be powered by a photovoltaic cell or cells without requiring battery power or other energy source. Using photovoltaic cells can afford the ability to use smaller and less carbon footprint intensive alternatives to batteries. The resulting “battery-free” electronic devices can have far less volume devoted to power supply and may be indefinitely powered without battery recharging or replacement. These “battery-free” electronic devices may have other energy storage elements such as capacitors. In certain implementations, electronic devices described herein may include batteries or other energy storage elements to store energy generated by the energy harvesting elements or as an alternative or supplemental energy source.

I. Mechanical User Interfaces with Integrated Energy Harvesting Elements

In some embodiments, the mechanical user interfaces include buttons or pads that are responsive to one or more user actions such as, e.g., pressing, tapping, touching, and swiping. Some examples of mechanical user interfaces that can integrate one or more energy harvesting elements include, e.g., a directional pad (D-pad), a touch pad, a button, a knob, a rocker switch, etc.

In some embodiments, a mechanical user interface includes a translucent UI component that can receive input such as a pressure from a user and allow for transmission of ambient light from an exterior environment to an energy harvesting element within the mechanical user interface. The translucent UI component may be any appropriate size or shape. The translucent UI component may have any curvature or lack thereof, texture, and coloration as suitable for the overall appearance if it is optically transparent and allows for transmission of light to the photovoltaic element. Examples of materials that can be used include polycarbonate. While the translucent UI component may be a fairly simple molded piece of plastic, more complex components such as light pipes or microlouvers may be used in some embodiments. In some embodiments, the translucent UI component may include multiple translucent parts, e.g., a molded piece of plastic covered by a translucent thin film.

In some examples, the translucent UI component may be provided at or near an outer surface of the housing of the electronic device to facilitate acceptance of pressure or other input from the user. For example, the outer surface of the translucent UI component may be located at the outside of the housing exposed to the exterior environment to be able to receive pressure directly from the user and also be able to transfer ambient light from the exterior environment. In another example, the mechanical user interface may include a layer of translucent material disposed over the translucent UI component.

Photovoltaic elements integrated into mechanical user interfaces can operate as energy harvesting elements for electronic devices. The photovoltaic element may be a single photovoltaic cell or include multiple photovoltaic cells, e.g., two or more photovoltaic cells arranged in a one-dimensional or two-dimensional array. In some embodiments, the photovoltaic cell is a thin-film solar cell. Thin-film solar cells are typically formed through depositing one or more layers (thin films) of photovoltaic material onto a substrate, using semiconductor device manufacturing methods. Thin-film solar cells include dye-sensitized solar cells (DSSCs), also referred to as dye-sensitized photovoltaic cells. DSSCs may be a lower-cost alternative to traditional photovoltaic cells, which are non-dye sensitized and usually formed on a rigid, glass or metal substrate. In comparison. DSSCs can be manufactured with less expense (e.g., with a lesser quantity of platinum or other noble metals) and on a greater variety of substrates such as plastic or other flexible materials. In some cases, bifacial photovoltaic cells may be implemented. A bifacial photovoltaic cell generally refers to a photovoltaic cell that can harvest photons from both sides. For example, a bifacial photovoltaic cell may allow for harvesting of photons from both the anode-side and the cathode-side of the cell. In another example, a bifacial photovoltaic cell may be two monofacial photovoltaic cells (i.e., photovoltaic cells that harvest from one face) placed back-to-back to allow for harvesting of photons received from an outer side of each of the back to back cells. Some examples of appropriate photovoltaic cells that can be implemented into mechanical user interfaces are described in Section III. The photovoltaic cell of various implementations can capture photons and generate energy from ambient light of various sources such as, for example, LED light, compact fluorescent light, incandescent light, sunlight from interior side of a window; etc.

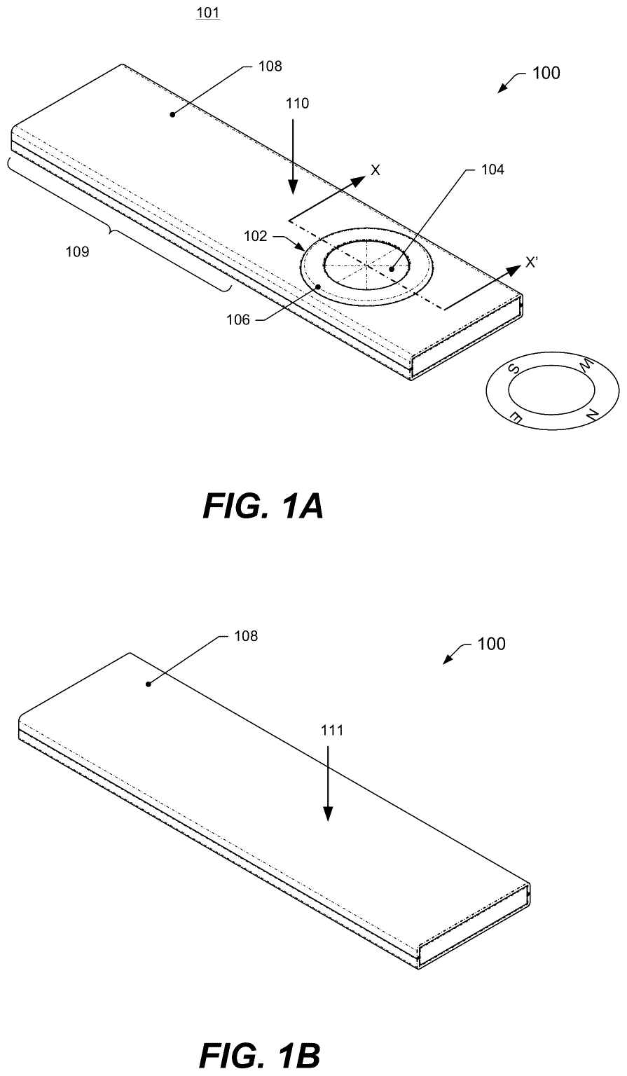

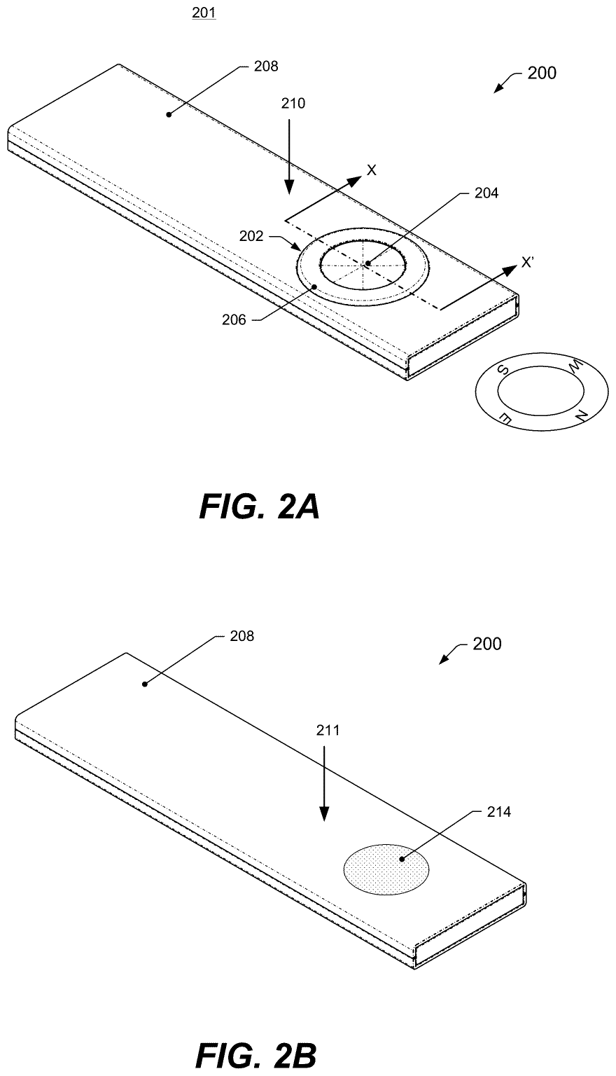

A photovoltaic element generally has a photovoltaically active area. The photovoltaic element and its active area may each be any appropriate shape. In some embodiments, the active area may be a square, e.g., a 5 cm² square. A square can be advantageously used to efficiently maximize photon collection when placed under a circular light facing surface such as shown in FIGS. 1A and 2A described below. In other embodiments, a rectangular or other shape active area may be used. The size of the active material is at least that sufficient to power the device. Example minimum dimensions may be 14 mm to 24 mm. In some embodiments, the bottom of the photovoltaic element (e.g., the rear glass pane) is painted black. This serves to increase efficiency of the cell and can be advantageous for the overall appearance of the user interface. Other transmissive, attenuating, or reflective coatings and/or colors may be used as appropriate.

In certain implementations, the mechanical user interface includes a bezel (e.g., ring-shaped or polygon-shaped) that receives directional user input. In some cases, the bezel surrounds and constrains the translucent UI component. The bezel may be part of the electronic device housing or may be part of the mechanical user interface. In some cases, the frame can receive directional input in the form of pressure at different points or segments along its perimeter. For example, a pressure received along a first segment of the bezel may indicate a North(N) directional input, along a second segment of the bezel may indicate West(W) directional input, along a third segment of the bezel may indicate a South(S) directional input, and along a fourth segment of the bezel may indicate East(E) directional input. In another example (sometimes referred to herein as a “rocker switch” or “rocker control” implementation), a pressure received along a first half segment of the bezel may indicate a first directional input (e.g., up/left) and a pressure received along a second half segment of the bezel may indicate a second directional input (e.g., down/right). In yet another example, pressure along the bezel at different points along the circumference may indicate directional input in more than four directions. The directional input in the form of pressure on the bezel is transferred away from the photovoltaic cell and to one or more of the directional switches via one or more pressure distribution elements.

In certain embodiments, the mechanical user interface includes one or more pressure redistribution elements to redistribute pressure such that direct pressure on the underlying photovoltaic element is eliminated or reduced. For example, the pressure redistribution element(s) may receive pressure from user input and transfer pressure away from the photovoltaic cell and to one or more switches. The switches may be mounted on a circuit board (e.g., printed circuit board (PCB)) in a shared housing with other components of the electronic device. In some cases, the switches include a center switch, which when activated indicates “ok.” “enter,” etc. For example, a pressure received at the translucent UI component may be transferred away from the photovoltaic cell and to a center switch via one or more pressure distribution elements. In addition or alternatively, the switches may include a plurality of directional switches that, when activated, indicate directional input.

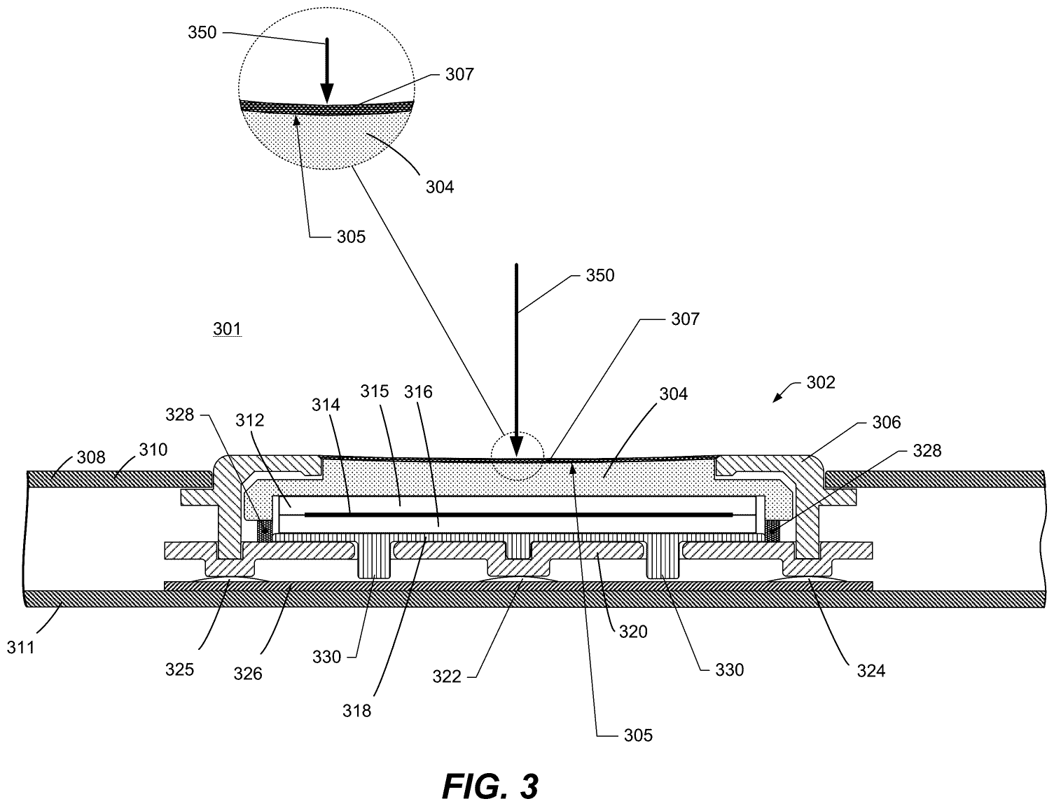

In the example of the mechanical user interface depicted in FIGS. 3-6 and 7-9, the user interface includes various pressure redistribution features (e.g., posts 328 and 728) to redistribute pressure such that direct pressure on the underlying photovoltaic element is eliminated or reduced. In alternate embodiments, photovoltaic elements that can withstand pressure may be used. Also in alternate embodiments, a photovoltaic element may be positioned away from the translucent UI component without the use of pressure redistribution features. For example, refractive and/or or diffractive elements may be used. In some embodiments, a light pipe (internal reflector element) or microlouver may be used to transmit light from the translucent UI component to the photovoltaic element. In some embodiments, the translucent component may touch-sensitive. For example, it may be a capacitive or resistive touch screen. In some embodiments, capacitive and/or resistive sensing may be used in place of the mechanical switches described above. Pressure redistribution features may or may not be used in such devices.

In some cases, the housing of an electronic device may include a frontside and a backside. For example, the housing may have two halves or portions one portion with the frontside and one with the backside where the frontside portion and the backside portion can mate and connect (e.g., removably connect) with each other. In certain implementations, an electronic device includes a translucent UI component located at the frontside of the housing to allow ambient light impinging the translucent UI component from the exterior environment to pass directly to a first light facing surface of the photovoltaic cell located within the housing. In some of these implementations, the backside portion of the housing also includes a translucent window configured to allow ambient light from the exterior environment to pass to a second light facing surface of the photovoltaic cell. In these implementations, the photovoltaic cell such as a bifacial photovoltaic cell can harvest photons from ambient light received at both the backside and the frontside of the housing.

In some embodiments, the photovoltaic element may be mounted to components of the mechanical user interface (e.g., D-pad) using one or more compressible foam layers. For example, a photovoltaic cell may be disposed between two foam layers in front and behind the photovoltaic cell in a “foam mount” configuration. In this configuration, the photovoltaic cell is allowed to “float” between the two foam layers which can help dampen loads to the photovoltaic cell from, e.g., impact to the electronic device and high-frequency vibrations and aide in photovoltaic cell longevity. In one foam mount implementation, a first foam layer is disposed between a frontside of the photovoltaic cell and the translucent UI component and a second foam layer is disposed between the backside of the photovoltaic cell and an inner face of a backplate at the backside of the housing. The first and/or second foam layers may be in the form of an unbroken ring of bonded foam such as a compressible foam gasket. In one case, the second foam layer is an unbroken mat. The first foam layer may be bonded to the frontside of the photovoltaic cell outside the perimeter of the active area of the photovoltaic cell. The first and/or second foam layers may be bonded using an adhesive such as a pressure sensitive adhesive (e.g., as 468MP or 300MP by 3M Corporation®). In one implementation, a first foam layer (e.g., THK40) modulus 15 density Poron foam) has a thickness of above 0.79 mm and the second foam layer (e.g., 40 modulus 15 density Poron foam) has a thickness of above 1.57 mm.

In another example, the frontside of the photovoltaic element is bonded directly to the inner surface of the mechanical user interface in a “direct mount” configuration. The photovoltaic element may be bonded to the mechanical user interface using a clear adhesive to allow light to transmit. The direct mount configuration has the benefit of reducing refractive changes between the photovoltaic cell and the exterior environment and allowing for a thinner stack up. In some of these examples, a foam layer may be disposed between the backside of the photovoltaic cell and an inner face of a backplate at the backside of the housing to help dampen loads.

Example embodiments in which a photovoltaic element is integrated into a mechanical user interface in the form of a directional pad (D-pad) of a remote control device are described with reference to FIGS. 1A-1B, 2A-2B, 3, 4, 5, 6, 7, 8, 9, and 10. Although these mechanical user interfaces are shown as part of remote control electronic devices, it would be understood that these mechanical user interfaces or components thereof can be implemented in other electronic devices such as a keyboard, etc. Also, the mechanical user interfaces can be implemented in other forms such as a touch pad.

FIGS. 1A and 1B depict an example of a remote control electronic device 100 including a mechanical user interface in the form of a directional pad (D-pad) 102. The remote control electronic device 100 includes a housing 108 having a frontside 110 and a backside 111. D-pad 102 is provided at the frontside 110 of the housing 108. D-pad 102 includes a translucent UI component 104 and a bezel 106 surrounding and constraining translucent UI component 104. D-pad 102 allows for four-way directional control in cardinal directions (North(N), South(S), East(E), and West(W)) by pressing up/down (North(N)/South(S)) and left/right (West(W)/East(E) along a perimeter of bezel 106 as well as a center trigger button at translucent UI component 104 that allows the user to select or indicate “ok.” “enter.” etc. A D-pad that allows for fewer or more directions of control may be used according to other implementations. For example, a D-pad configured for directional control in two directions (rocker control) by pressing up/down or left/right on bezel 106 may be implemented. As another example, a D-pad that allows for control in more than four directions by pressing different portions along the perimeter of bezel 106 may be implemented.

D-pad 102 also includes a photovoltaic element (e.g., photovoltaic element 312 in FIG. 3) housed within housing 108 beneath translucent UI component 104. The photovoltaic element is configured to receive ambient light from the exterior environment 101 through translucent UI component 104 and generate electric power from light it receives. Electric power generated by the photovoltaic element can be used to power the remote control electronic device 100. The photovoltaic element may be, for example, a photovoltaic cell or an array of photovoltaic cells. Some examples of suitable photovoltaic cells are described in Section III.

In some embodiments, a photovoltaic element integrated into a mechanical user interface is the entire power producing component of the electronic device. In these cases, any photovoltaic element capable of providing the power requirements of the electronic device may be used. In the example of FIGS. 1A and 1B, for instance, the entire power producing component of the remote control electronic device 102 may be the photovoltaic element disposed beneath the translucent UI component 104. This frees the volume indicated at 109 (which might otherwise contain one or more batteries in a battery-operated device) for other components, void space, etc.

FIGS. 2A and 2B depict another example of a remote control electronic device 200 including a mechanical user interface in the form of a directional pad (D-pad) 202 in a bifacial configuration. The remote control electronic device 200 includes a housing 208 having a frontside 210 and a backside 211. D-pad 202 is at the frontside 210 of the housing 208. D-pad 202 includes a translucent UI component 204 and a bezel 206 surrounding and constraining translucent UI component 204. D-pad 202 allows for four-way directional control in the cardinal directions (North(N), South(S), East(E), and West(W)) by pressing up/down (North(N)/South(S)) and left/right (West(W)/East(E) along a perimeter of bezel 206 as well as a center trigger button at translucent UI component 204 that allows the user to select or indicate “ok.” “enter.” etc. A D-pad that allows for fewer or more directions of control may also be used according to other implementations.

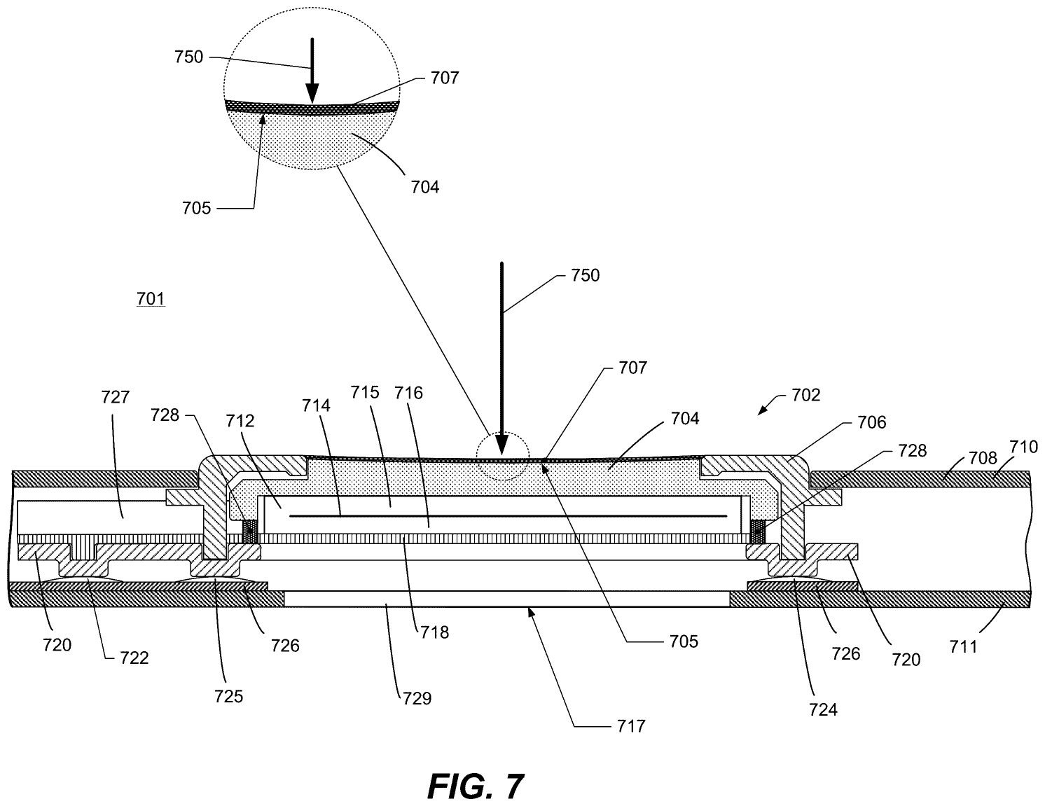

D-pad 202 also includes a bifacial photovoltaic element (e.g., photovoltaic element 712 in FIG. 7) housed within device housing 208 beneath translucent UI component 204. Electric power generated by the bifacial photovoltaic element can be used to power the remote control electronic device 200. The bifacial photovoltaic element may be, for example, a single bifacial photovoltaic cell or an array of bifacial photovoltaic cells. Some examples of suitable bifacial photovoltaic cells are described in Section III.

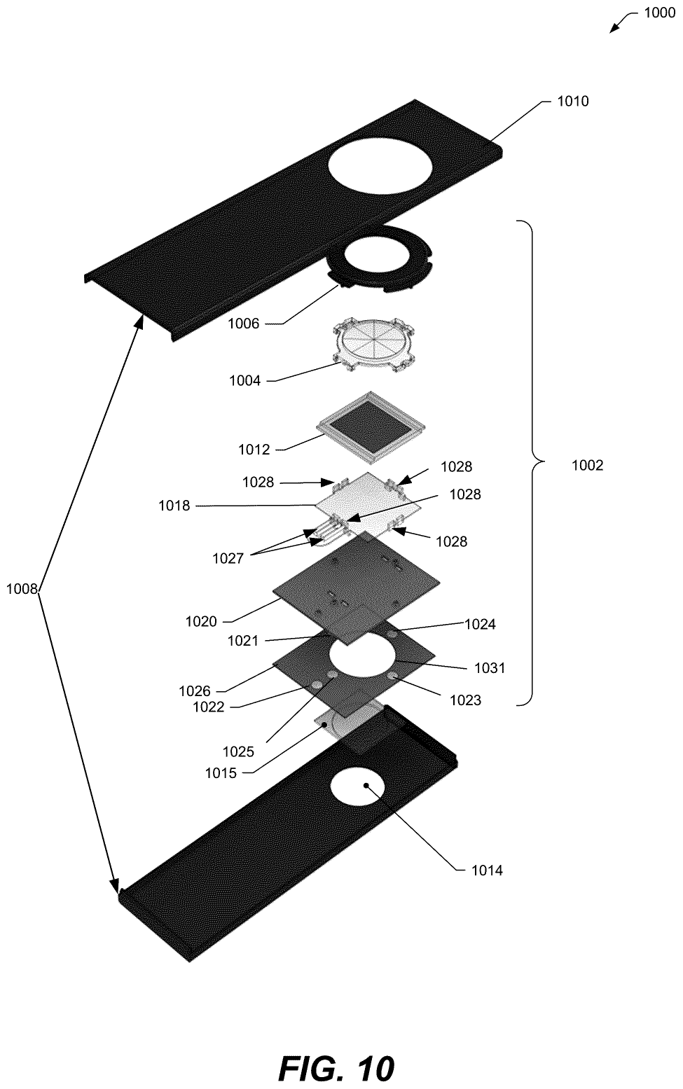

In the example shown in FIGS. 2A-2B, the translucent UI component 204 of D-pad 202 is at an outer surface of the frontside 210 of the housing 208 and a translucent window 214 is in the outer wall of the backside 211 of housing 208. Translucent UI component 204 and translucent window 214 allow light to pass from the exterior environment 201 to reach both sides of the bifacial photovoltaic element within housing 208. The translucent window 214 may be an aperture in the backside 211 of the housing with a translucent layer (e.g., translucent layer 1015 in FIG. 10), In this bifacial configuration, the bifacial photovoltaic element can harvest light received from both sides. In this manner, light can be absorbed, and energy harvested by the bifacial photovoltaic element, even when either the translucent window 214 or the translucent UI component 204 is covered.

FIGS. 3-5 show a cross-sectional view of an example of components of a mechanical user interface in the form of a D-pad 302. D-pad 302 is shown in an electronic device housing 308 having a frontside 310 and a backside 311. D-pad 302 may have components of D-pad 102 described with respect to FIGS. 1A and 1B. The cross-sectional view of D-pad 302 in FIGS. 3-5 depicts an example of features of D-pad 102 at cross-section X-X′ in FIG. 1A, according to one embodiment.

In the example shown in FIGS. 3-5. D-pad 302 includes a translucent UI component 304 and a bezel 306 surrounding and constraining translucent UI component 304. Translucent UI component 304 includes a top, light facing surface 305 through which light can be received from external environment 301. In this illustrated example, translucent UI component 304 includes an optional translucent pad 307 (e.g., a layer of silicone material) connected at its perimeter edge to an inner edge of a central aperture of bezel 306. As shown in the expanded view, translucent pad 307 can accept a pressure load 350 from user interaction (e.g., pressing), and pass at least a portion of the pressure load 350 to translucent UI component 304. In another implementation, translucent pad 307 may be omitted and translucent UI component 304 accepts the pressure load 350 directly from user interaction.

D-pad 302 allows for four-way directional control in the cardinal directions (North(N), South(S), East(E), and West(W)) by pressing up/down (North(N)/South(S)) and left/right (West(W)/East(E) along the perimeter of the bezel 306 as well as a center trigger button at translucent UI component 304 that allows a user to select or indicate “ok.” “enter.” etc. A D-pad that allows for fewer or more directions of control may also be used according to other implementations.

D-pad 302 also includes an integrated photovoltaic element 312 having a photovoltaically active area 314. Photovoltaically active area 314 is disposed between two sheets of glass 315, 316 and is co-extensive with and extends past the lateral dimensions of light facing surface 305 of translucent UI component 304. In other implementations, the active area 314 only extends within the lateral dimensions of light facing surface 305 or extends further past the lateral dimensions of light facing surface 305. Photovoltaic element 312 is configured to receive ambient light from an exterior environment 301 through translucent UI component 304 and generate electric power from light received. Electric power generated by photovoltaic element 312 can be used to power the electronic device. The photovoltaic element 312 may be, for example, a photovoltaic cell or an array of photovoltaic cells. Some examples of appropriate photovoltaic cells are described in Section III. In some cases, the photovoltaic element 312 is the entire power producing component of the electronic device in which it is disposed. In these cases, any photovoltaic element capable of providing the power requirements of the electronic device may be used.

In the example shown in FIGS. 3-5, bezel 306 and translucent UI component 304 are rigid parts that fit within housing 308. The D-pad 302 also includes a circuit board 326 with five board mounted switches (a center switch 333 and four directional switches for four-way directional control in the cardinal directions (North(N), South(S), East(E), and West(W)) that can be activated by user interaction with D-pad 302. In the cross-sectional view in FIGS. 3-5, three of the five switches are shown: center switch 333 corresponding the center button of the D-pad 302 that can be triggered by appropriate pressure received at the translucent UI component 304 and two directional switches 324, 325. The first directional switch 324 can be triggered by appropriate pressure received at a segment of bezel 306 at, or near, the North (N) cardinal position. The second directional switch 325 can be triggered by appropriate pressure received at a segment of the bezel 306 at, or near, the South (S) cardinal position. The other two directional switches (not shown) can be triggered by appropriate pressure received at a segment of bezel 306 at, or near, the East (E) cardinal position and at, or near, the West (W) cardinal position respectively.

D-pad 302 includes one or more pressure redistribution elements configured to transfer a pressure load received at translucent UI component 304 and/or at bezel 303 away from photovoltaic element 312 and to the five board mounted switches. The pressure redistribution elements include a backplate 318 disposed beneath photovoltaic element 312, a plurality of posts 328, and a flexible gasket 320 in contact with the board mounted switches. The flexible gasket 320 may be made of any flexible or compliant material such as silicone. Posts 328 may be connected to, or in contact with, backplate 318 and/or to translucent UI component 304.

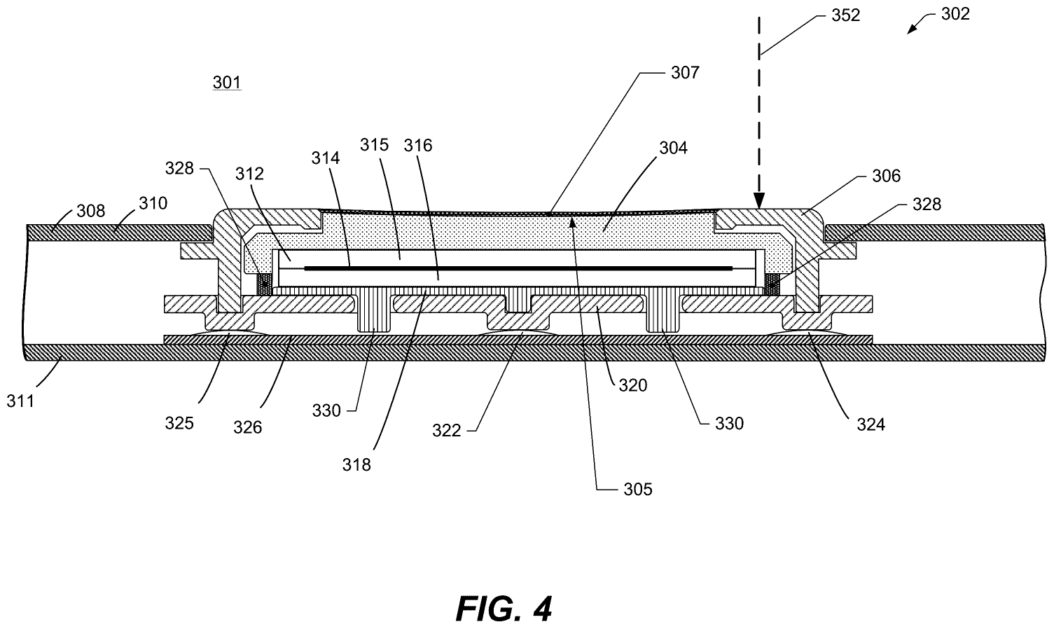

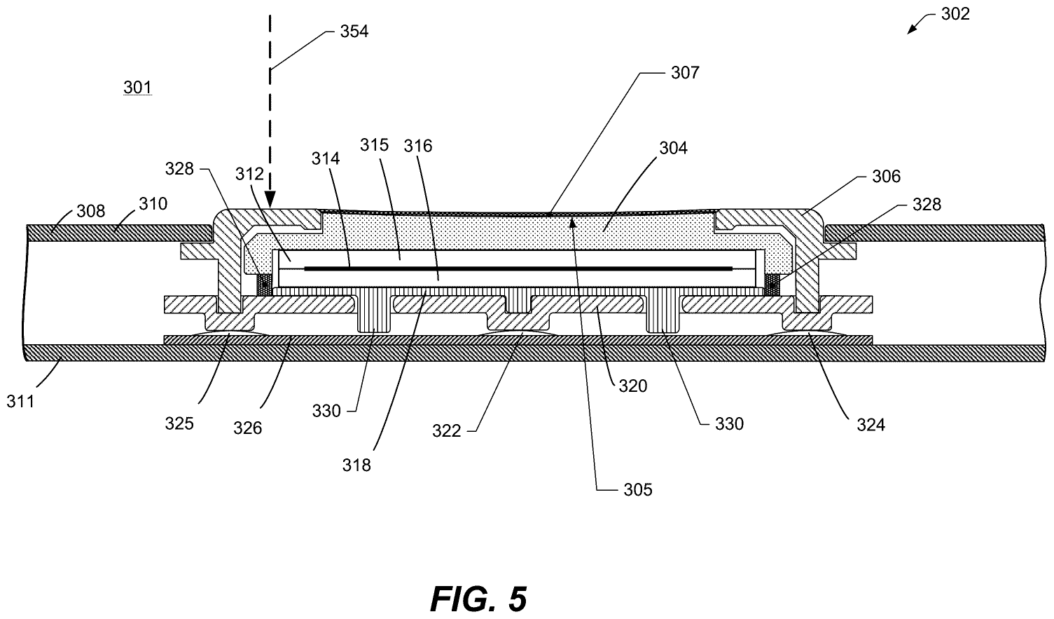

Backplate 318 is a rigid part (e.g., polycarbonate or other appropriate plastic) that accepts a pressure load from user interaction (e.g., pressing) with translucent pad 307 that is transferred to translucent UI component 304. Bezel 306 and backplate 318 can interface with flexible gasket 320. Translucent UI component 304 extends around the sides of the photovoltaic element 312 to contact posts 328. Posts 328 and translucent UI component 304 are also rigid parts. In use, a user applies a pressure load (e.g., with a thumb or other finger) to, e.g., light facing surface 305 of the translucent UI component 304 or to a translucent pad 307 disposed over translucent UI component 304. For example, as shown in FIG. 3, a pressure load 340 is applied. The pressure load 350 is transferred via posts 328 to backplate 318, which in turn transfers the load to flexible gasket 320. The flexible gasket 320, in turn, compresses locally and transfers at least a portion of pressure load 350 to center switch 322 for activation. Backplate 318 also includes, or is attached to, stops 330 that can contact circuit board 326 and help prevent any over-compression to photovoltaic element 312. To activate directional switches 324, 325, a user applies pressure to bezel 306, which interfaces with flexible gasket 320. For example, as shown in FIG. 4, a pressure load 352 applied along a first portion of bezel 306 at, or near, the North (N) cardinal position can be transferred to flexible gasket 320, which in turn, compresses locally and transfers at least a portion of pressure load 352 to first directional switch 324. As shown in FIG. 5, a pressure load 354 applied along a second portion of bezel 306 at, or near, the South (S) cardinal position can be transferred to flexible gasket 320, which in turn, compresses locally and transfers at least a portion of pressure load 354 to second directional switch 325. Any pressure placed on translucent UI component 304 during user interaction with bezel 306 is transferred off the photovoltaic element 312 as described above.

The photovoltaic element 312 may be mounted within D-pad 302 using various techniques. In one example, the photovoltaic element 312 is bonded directly to the inner surface of translucent UI component 304 in a direct mount configuration. In one implementation, a compressive foam layer may be disposed between the photovoltaic element 312 and backplate 318. In another example, the photovoltaic element 312 may be mounted between translucent UI component 304 and backplate 318 using one or more compressible foam layers in a foam mount configuration. In this configuration, a first foam layer is disposed between photovoltaic element 312 and translucent UI component 304 and a second foam layer is disposed between the photovoltaic element 312 and backplate 318.

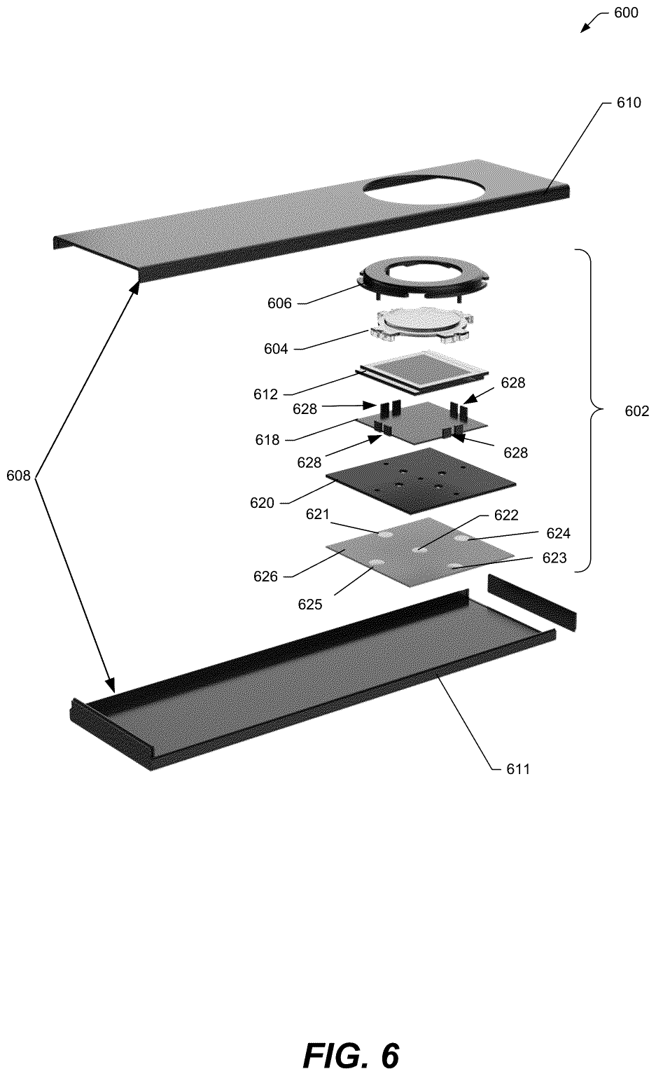

FIG. 6 is an exploded view of components of a remote control electronic device 600, according to an embodiment. The remote control electronic device 600 includes a housing 608 having a frontside 610 and a backside 611. The remote control electronic device 600 also includes a mechanical user interface in the form of a D-pad 602. The components of D-pad 602 may be similar to components of D-pad 302 described with respect to FIGS. 3-5.

In FIG. 6. D-pad 602 includes a translucent UI component 604, a bezel 606, an integrated photovoltaic element 612, a backplate 618 with posts 628, a flexible gasket 620, and a circuit board 626. During operation, translucent UI component 604 can accept a pressure load from user interaction (e.g., pressing), Circuit board 626 has five board mounted switches including a center switch 622, a first directional control switch 624 for the cardinal North(N) direction, a second directional control switch 625 for the cardinal South(S) direction, a third directional control switch 623 for the cardinal East(E) direction, and a fourth directional control switch 621 for the cardinal West(W) direction. A D-pad that allows for fewer or more directions of control may also be used according to other implementations. The photovoltaic element 612 may be, for example, a photovoltaic cell or an array of photovoltaic cells. Some examples of appropriate photovoltaic cells are described in Section III.

In the example shown in FIG. 6, during operation, a pressure load received at translucent UI component 604 may be moved away from photovoltaic element 612 and to the center switch 622 and a pressure load received at the bezel 603 may be moved away from photovoltaic element 612 to one or more of the directional switches 621, 623, 624, and 625. The pressure may be redistributed by one or more of the backplate 618, the posts 628, and the flexible gasket 620. The flexible gasket 620 may be made of any flexible or compliant material such as silicone. Posts 628 may be connected to, or in contact with, backplate 618 and/or to translucent UI component 604. For instance, backplate 618 is a rigid part (e.g., polycarbonate or other appropriate plastic) that accepts a pressure load from user interaction (e.g., pressing) with translucent UI component 604. Bezel 606 and backplate 618 can interface with flexible gasket 620. Translucent UI component 604 extends around the sides of the photovoltaic element 612 to contact posts 628. Posts 628 and translucent UI component 604 are also rigid parts. In use, a user applies pressure to translucent UI component 604. The pressure load is transferred via posts 628 to backplate 618, which in turn transfers the load to flexible gasket 620, which compresses and transfers load to center switch 622. Backplate 618 also includes, or is attached to, stops 630 that can contact circuit board 626 and help prevent any over-compression to photovoltaic element 612. To activate directional switches 621, 623, 624, and 625, a user applies a pressure load to bezel 606, which interfaces with flexible gasket 620, which compresses and transfers load to one or more of the directional switches.

FIGS. 7-9 show a cross-sectional view of an example of components of a mechanical user interface in the form of a D-pad 702 in a bifacial configuration. D-pad 702 is in an electronic device housing 708 including a frontside 710 and a backside 711 with a translucent window 714. D-pad 702 may have components of D-pad 202 described with respect to FIGS. 2A and 2B. The cross-sectional view of D-pad 702 in FIGS. 7-9 depicts an example of features of D-pad 202 at cross-section X-X′ in FIG. 2A, according to one embodiment.

D-pad 702 includes a translucent UI component 704 having an integrated bifacial photovoltaic element 712 and a bezel 706 surrounding and constraining translucent UI component 704. The device housing 708 includes translucent window 714 in an outer wall of backside 711. Translucent UI component 704 has a top, frontside light facing surface 705 through which light can be received from external environment 701 from the frontside 710 of the housing 708. Translucent window 714 has a backside light facing surface 705 through which light can be received from external environment 701 from the backside 711 of the housing 708. In addition, any other components between the translucent window 714 and the bifacial photovoltaic element 712 have cutouts (e.g., cutout 1031 in circuit board 1026 in FIG. 10) and/or are at least partially made of materials with reasonable light transparency to allow light to pass from an exterior environment 701 through translucent window 712 to bifacial photovoltaic element 712. The translucent components and/or cutouts allow light to pass from the exterior environment 701 to reach both sides of the bifacial photovoltaic element 712. In this manner, light can be absorbed, and energy harvested by the bifacial photovoltaic element 712, even when either the translucent window 714 or the translucent UI component 704 is covered.

In the example shown in FIGS. 3-5, translucent UI component 704 also includes an optional translucent pad 707 (e.g., a layer of silicone material) connected at its perimeter edge to an inner edge of a central aperture of bezel 706. As shown in the expanded view in FIG. 7, optional translucent pad 707 can accept a pressure load 750 from user interaction (e.g., pressing), and pass the pressure load 750 to translucent UI component 704. In another implementation, translucent pad 707 may be omitted and translucent UI component 704 accepts the pressure load 750 directly from user interaction.

D-pad 702 allows for four-way directional control in the cardinal directions (North(N), South(S), East(E), and West(W)) by pressing up/down (North(N)/South(S)) and left/right (West(W)/East(E) along the perimeter of the bezel 706 as well as a center trigger button at translucent UI component 704 that allows a user to select or indicate “ok.” “enter.” etc. A D-pad that allows for fewer or more directions of control may also be used according to other implementations.

Bifacial photovoltaic element 712 includes a photovoltaically active area 714 disposed between two sheets of glass 715, 716. Photovoltaically active area 714 is co-extensive with and extends past the lateral dimensions of light facing surface 705 of translucent UI component 704. In other implementations, active area 714 only extends within the lateral dimensions of light facing surface 705 or extends further past the lateral dimensions of light facing surface 705. Bifacial photovoltaic element 712 is configured to receive ambient light from exterior environment 701 through translucent UI component 704 and generate electric power from light received. Electric power generated by bifacial photovoltaic element 712 can be used to power the electronic device. Bifacial photovoltaic element 712 may be, for example, a single cell or an array of cells. Some examples of appropriate bifacial photovoltaic cells are described in Section III. In some cases, bifacial photovoltaic element 712 is the entire power producing component of the electronic device in which it is disposed. In these cases, any bifacial photovoltaic element capable of providing the power requirements of the electronic device may be used.

In the example shown in FIGS. 7-9, bezel 706 and translucent UI component 704 are rigid parts that mainly fit within housing 708. The D-pad 702 also includes a circuit board 726 having a cutout 729 through which light can pass from backside light facing surface 717. Circuit board 726 includes five board mounted switches (an offset center switch 722 and four directional switches for four-way directional control in the cardinal directions (North(N), South(S), East(E), and West(W)) that can be activated by user interaction with D-pad 702. In the cross-sectional view in FIGS. 7-9, three of the five switches are shown: the offset center switch 733 corresponding to the center button of D-pad 702 and two directional switches 724, 725. Offset center switch 722 is mounted to circuit board 726 outside the inner perimeter edge of cutout 729. Offset center switch 722 can be triggered by an appropriate pressure received at translucent UI component 704 as discussed below. The first directional switch 724 can be triggered by appropriate pressure received at a segment of bezel 706 at, or near, the North (N) cardinal position. The second directional switch 725 can be triggered by appropriate pressure received at a segment of the bezel 706 at, or near, the South (S) cardinal position. The other two directional switches (not shown) can be triggered by appropriate pressure received at a segment of bezel 706 at, or near, the East (E) cardinal position and at, or near, the West (W) cardinal position respectively.

D-pad 702 also includes a backplate 718, an arm 727, a plurality of posts 728, and a flexible gasket 720. One or more of the components of D-pad 702 are configured to transfer pressure load received at translucent UI component 704 and/or at bezel 703 away from photovoltaic element 712 and to the five board mounted switches. Bezel 706 and backplate 718 can interface with flexible gasket 720. Flexible gasket 720 is in contact with the board mounted switches and may be made of any flexible or compliant material such as silicone. Arm 727, posts 728, and translucent UI component 704 are rigid parts.

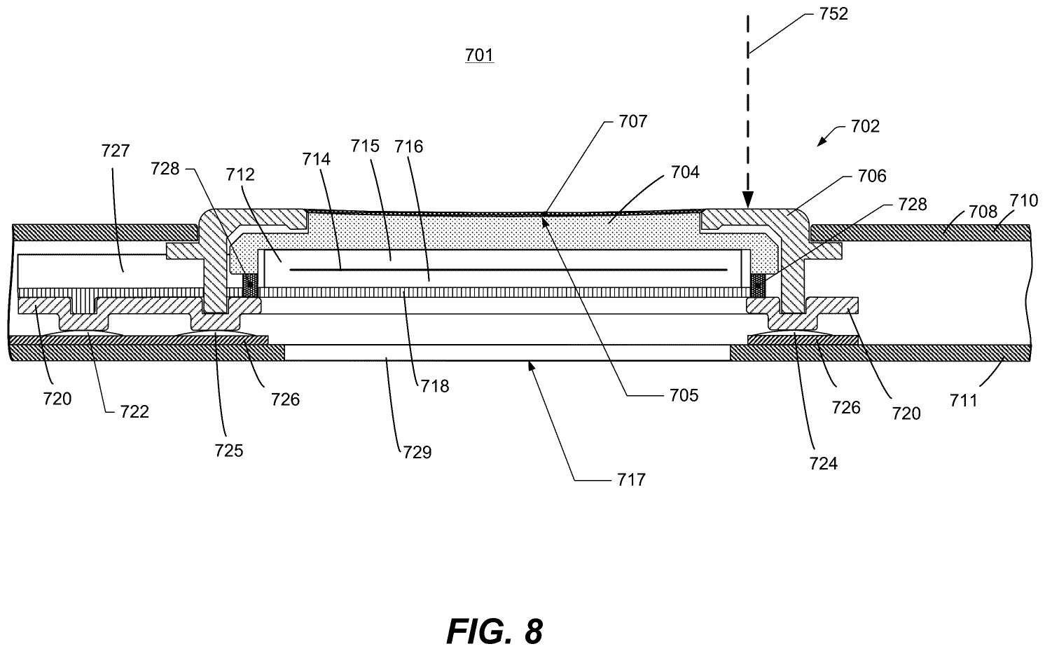

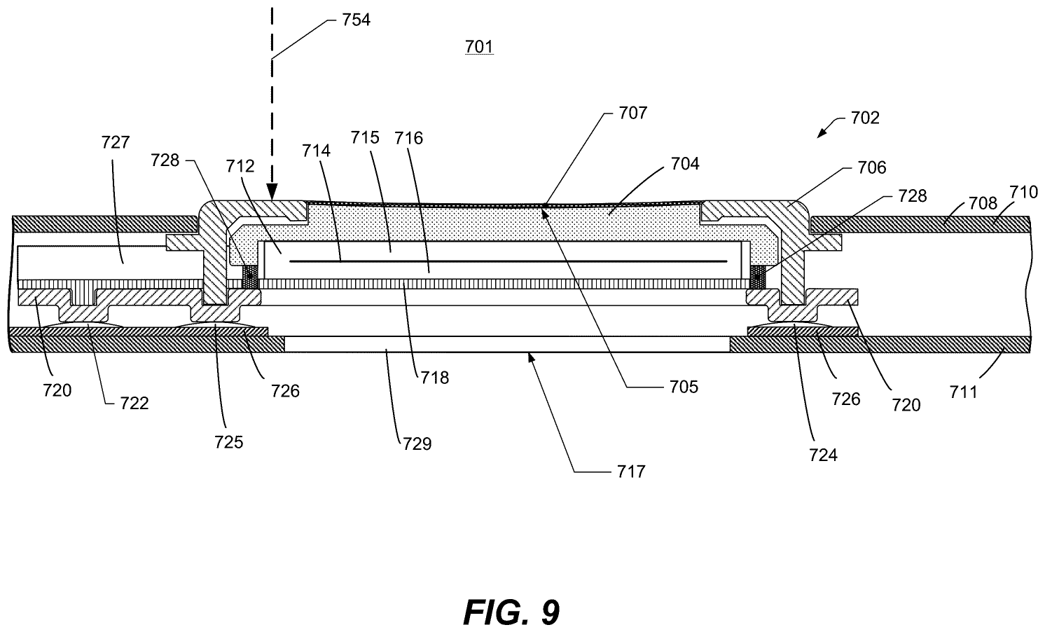

A proximal end of arm 727 is connected to, or in contact with, one or more of translucent UI component 704, posts 728, or backplate 718. The arm 727 extends outside the lateral dimensions of cutout 729 in circuit board 726. Cutout 729 in circuit board 726 has a perimeter edge outside the lateral dimensions of light facing surface 705 of translucent UI component 704 to pass light from backside light facing surface 717 through the translucent backplate 718 to photovoltaic element 712. Translucent UI component 704 extends around the sides of the photovoltaic element 712 to contact posts 728 and/or arm 727. In use, a user applies pressure (e.g., with a thumb or other finger) to light facing surface 705 of the translucent UI component 704 or to the optional translucent pad 707 disposed over translucent UI component 704. For example, as shown in FIG. 7, a pressure load 750 is applied. The pressure load at translucent UI component 704 is transferred to backplate 718 and the one or more arms 727 shift the pressure load outboard to outside the perimeter edge of cutout 729 to transfer load to a portion of flexible gasket 720 above offset center switch 722. The flexible gasket 720 compresses locally and transfers at least a portion of the pressure load 750 to offset center switch 722. To activate directional switches 724, 725, a user applies pressure to bezel 706, which interfaces with flexible gasket 720. For example, as shown in FIG. 8, a pressure load 752 applied along a first portion of the bezel 706 at, or near, the North (N) cardinal position can be transferred to flexible gasket 720, which in turn, compresses locally and transfers at least a portion of the pressure load 752 to first directional switch 724. As shown in FIG. 9, a pressure load 754 applied along a second portion of the bezel 706 at, or near, the South (S) cardinal position can be transferred to flexible gasket 720, which in turn, compresses locally and transfers at least a portion of pressure load 754 to second directional switch 725. Any pressure placed on translucent UI component 704 during user interaction with bezel 706 is transferred away from photovoltaic element 712 as described above.

The photovoltaic element 712 may be mounted within D-pad 702 using various techniques. In one example, the photovoltaic element 712 is bonded directly to the inner surface of translucent UI component 704 in a direct mount configuration. In one implementation, a compressive foam layer may be disposed between the photovoltaic element 712 and backplate 718. In another example, the photovoltaic element may be mounted between translucent UI component 704 and backplate 718 using one or more compressible foam layers in a foam mount configuration. In this configuration, a first foam layer is disposed between photovoltaic element 712 and translucent UI component 704 and a second foam layer is disposed between the photovoltaic element 712 and backplate 718.

It will be understood that various components of the D-pad 102, 302 and 702 described above may be combined into a single part or split into multiple parts as appropriate. For example, posts 328 and 728 may be formed as part of translucent UI component 304 or 704 respectively or as separated parts attached to translucent UI component 304 or 704 respectively. Also, translucent UI components 304 and 704 may include non-translucent portions that do not interfere with light transmission from light facing surface 305 to the active area 314 of the photovoltaic element 312.

FIG. 10 is an exploded view of components of a remote control electronic device 1000, according to an embodiment. The remote control electronic device 1000 includes a housing 1008 having a frontside 1010 and a backside 1011 having a translucent window 1014 with a translucent layer of material 1015. The remote control electronic device 1000 also includes a mechanical user interface in the form of a D-pad 1002 having an integrated bifacial photovoltaic element 1012. The components of D-pad 1002 may be similar to components of D-pad 702 described with respect to FIGS. 7-9.

D-pad 1002 includes a translucent UI component 1004, a bezel 1006 that can surround and constrain translucent UI component 304, integrated photovoltaic element 1012, a backplate 1018 with posts 1028 and two arms 1027, a flexible gasket 1020, and a circuit board 1026 with a cutout 1031. The backplate 1018 and flexible gasket 1029 may be made of a translucent material. Bezel 1006, translucent UI component 1004, backplate 1018 are rigid parts that fit within housing 1008. Backplate 1018 includes, or is attached to, stops 1030 that can contact circuit board 1026 and help prevent any over-compression to photovoltaic element 1012. Backplate 1018 includes, or is attached to, posts 1028. The stops 1030 and posts 1028 are also rigid parts.

Circuit board 1026 has five board mounted switches including an offset center switch 1022, a first directional control switch 1024 for the cardinal North(N) direction, a second directional control switch 1025 for the cardinal South(S) direction, a third directional control switch 1023 for the cardinal East(E) direction, and a fourth directional control switch 1021 for the cardinal West(W) direction. Offset center switch 1022 is mounted to circuit board 1026 outside the inner perimeter edge of cutout 1031. Offset center switch 1022 can be triggered by an appropriate pressure received at translucent UI component 704 as discussed below: The first directional switch 1024 can be triggered by appropriate pressure received at a segment of bezel 1006 at, or near, the North (N) cardinal position. The second directional switch 1025 can be triggered by appropriate pressure received at a segment of the bezel 1006 at, or near, the South (S) cardinal position. The other two directional switches (not shown) can be triggered by appropriate pressure received at a segment of bezel 1006 at, or near, the East (E) cardinal position and at, or near, the West (W) cardinal position respectively. The flexible gasket 1020 is in contact with the offset center switch 1022 and the directional switches 1021, 1023, 1024, and 1024. The arms 1027 of backplate 1018 and the bezel 1006 interface with flexible gasket 1020. The flexible gasket 1020 may be made of any flexible or compliant material such as silicone. A D-pad that allows for fewer or more directions of control may also be used according to other implementations. The photovoltaic element 1012 may be, for example, a photovoltaic cell or an array of photovoltaic cells. Some examples of appropriate photovoltaic cells are described in Section III.

During operation, translucent UI component 1004 and/or bezel 1006 can accept a pressure load from user interaction (e.g., pressing) and redistribute the load away from photovoltaic element 1012 and to one or more of the switches disposed on circuit board 1026. The pressure may be redistributed, for example, by implementing backplate 1018 with arms 1027 posts 1028 and/or flexible gasket 1020. For example, a pressure load received at translucent UI component 1004 may be transferred to backplate 1018. The arms 1027 can shift the pressure load outboard to outside the perimeter edge of cutout 1031 to transfer load to a portion of flexible gasket 1020 above offset center switch 1022. In turn, the flexible gasket 1020 compresses locally and transfers at least a portion of the pressure load to offset center switch 1022. A pressure load received at bezel 1003 may be moved away from photovoltaic element 1012 to one or more of the directional switches 1021, 1023, 1024, and 1025. For example, a user may apply a pressure load to bezel 1006, which interfaces with flexible gasket 1020. The flexible gasket 1029 may, in turn, compress locally and transfer load to one or more of the directional switches.

It would also be understood that although directional pads (D-pads) are described in several examples herein, other types of mechanical user interfaces implementing a transparent UI component and one or more load redistribution elements are within the scope the disclosure. For example, a button, knob, or rocker switch may include a translucent user interface component with an integrated photovoltaic cell according to other embodiments. The user interface component may include one or more pressure redistribution elements to substantially redistribute pressure received at the translucent user interface component away from the integrated photovoltaic cell.

The mechanical user interfaces may include the one or more of following aspects: use of small, high power density photovoltaic cells, features such that the look and feel of the user interface is consistent with the rest of the device, and user interaction without direct pressure on the photovoltaic cell to protect the photovoltaic cell.

### II. Energy Harvesting System

The photovoltaic element of certain examples described herein may be part of an energy harvesting system. The other components of the energy harvesting system, including an energy harvesting power management integrated circuit (PMIC) and electrical storage element(s), may be mounted on a printed circuit board housed within the electronic device housing.

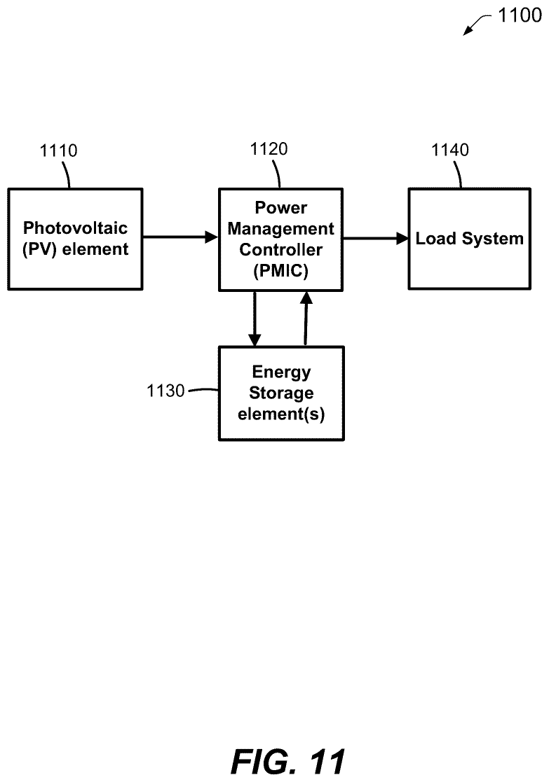

FIG. 11 is a simplified block diagram of an energy harvesting system 1100, according to embodiments. The energy harvesting system 1100 can be implemented as a single electronic device or as separate components that are electrically coupled to each other. For example, the components depicted in FIG. 11 may be mounted on a circuit board housed within the electronic device housing. However, the components can be combined or separated such that the features described with respect to these components are distributed differently than shown in FIG. 11.

Energy harvesting system 1100 includes a photovoltaic element 1110, a power management integrated circuit (PMIC) 1120, one or more energy storage elements 1130, and a load system 1140. Photovoltaic element 1110 operates as an energy harvesting element and may include, e.g., a single photovoltaic cell or multiple PV cells, e.g., two or more photovoltaic cells arranged in a one-dimensional or two-dimensional array. Photovoltaic element 1110 can be implemented using any of a variety of photovoltaic cell technologies such as those described in Section II. The photovoltaic element 1110 may be used as a supplemental power source or as a primary power source for the electronic device. PMIC 1120 may route harvested energy from the photovoltaic element 1110 to the one or more energy storage elements 1130 and deliver the stored energy to load system 1140. The one or more energy storage elements 1130 are configured to store energy transferred from the photovoltaic cell 1110. The one or more energy storage elements 1130 may include, for example, a primary storage element and a secondary storage element. Load system 1140 includes components that can operate to provide functionality to the electronic device. Load system 1140 can include one or more processing units such as a processor or a microcontroller. Each processing unit is operable to execute program instructions in the form of software or firmware. The load system 1140 may also include any number of components to provide the functionality such as input/output (I/O) devices, sensors, wireless communication devices, etc. The load system 1140 may include a user interface that integrates the photovoltaic element 1110. The one or more storage elements 1130 are configured to store energy in the form of electrical charge. One example of an energy storage element is a rechargeable battery. Another example is a supercapacitor.

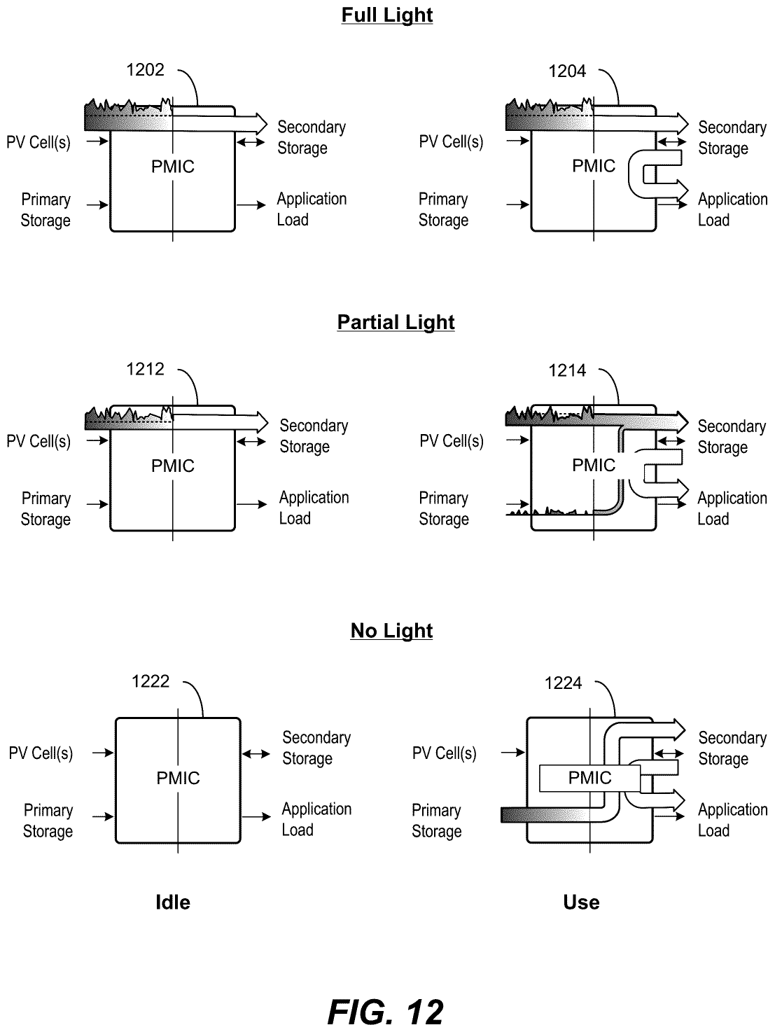

FIG. 12 is a simplified block diagram depicting some exemplary operations of energy harvesting system 1100 during a full light condition, a partial light condition, and a no light condition. In this example, the one or more energy storage elements include a primary storage element and a secondary storage element.

During a full light condition, photovoltaic element 1110 is illuminated by full light, photovoltaic element 1110 generates power, and PMIC 1120 directs the power generated to the secondary storage element when there is no application load (operation 1202), When there is an application load during a full light condition, PMIC 1120 directs power from the secondary storage element to load system 1140 (operation 1204),

During a partial light condition, when photovoltaic element 1110 is partially illuminated, photovoltaic element 1110 generates power and PMIC 1120 directs the power generated to the secondary storage element when there is no application load (operation 1212), When there is an application load during a partial light condition, PMIC 1120 draws power being generated from photovoltaic element 1110 first and then from the primary storage element, and directs the conditioned power to the secondary storage element and from the secondary storage element to load system 1140 (operation 1214).

During a no light condition, photovoltaic element 1110 is not illuminated, and without an application load, there is no power transfer (operation 1222), When there is an application load during a no light condition, PMIC 1120 draws power from the primary storage element, and feeds the power to the secondary storage element and directs that power from the secondary storage element to load system 1140 (operation 1224).

III. Photovoltaic cells

Any appropriate photovoltaic cell may be implemented in the photovoltaic elements discussed above. In some embodiments, the photovoltaic element includes a single, monolithic photovoltaic cell. In other embodiments, an array of photovoltaic cells may be included. A photovoltaic cell generally includes a cathode, one or more light absorbing layers, an electrolyte, and an anode.

Dye-sensitized photovoltaic cells

A photovoltaic element including a dye sensitive photovoltaic cell such as those described in U.S. Patent Publication 2020/395492, which is incorporated by reference herein for the purpose of describing cell architecture and dyes, may be used in some embodiments. Dye sensitive photovoltaic cells manufactured by Ambient Photonics, Inc. may be used. Further description of dyes that may be used may be found in PCT Publication 2020/014194, also incorporated by reference herein for the purpose of describe photovoltaic cells and components thereof.

In some embodiments, a photovoltaic cell is a dye-sensitized photovoltaic cell (DSPC), DSPCs use a dye to absorb light and initiate a rapid electron transfer to a nanostructured oxide such as TiO2. The mesoscopic structure of the TiO2 allows building of thick, nanoporous films with active-layer thicknesses of several microns. The dye is then adsorbed on the large surface area of the mesoporous TiO2. Charge balance and transport is achieved by a layer having a redox couple, such as iodide/triiodide, Co(II)/Co(III) complexes, and Cu(I)/Cu(II) complexes. In some cases, a dye-sensitized photovoltaic cell includes a cathode, an electrolyte, a porous dye-sensitized titanium dioxide film, and an anode.

In some cases, dye-sensitized photovoltaic cells may include a nonporous hole-blocking layer interposed between the anode and the dye-sensitized titanium dioxide film. The nonporous “hole-blocking” layer may comprise an organotitanium compound, such as a titanium alkoxide. The organotitanium compound may be polymeric, such as a polymeric titanium alkoxide. An exemplary polymeric titanium alkoxide is poly(n-butyl titanate), The nonporous or compact hole-blocking layer may also comprise titanium in the form of an oxide, such as compact anatase or rutile film. The thickness of the hole blocking layer may be from about 20 nm to about 100 nm. The nonporous hole blocking layer reduces/inhibits back electron transfer between redox species in the electrolyte and the electrode. The nonporous blocking layer may be applied to the anode using art-known techniques, such as gravure, silkscreen, slot, spin or blade coating.

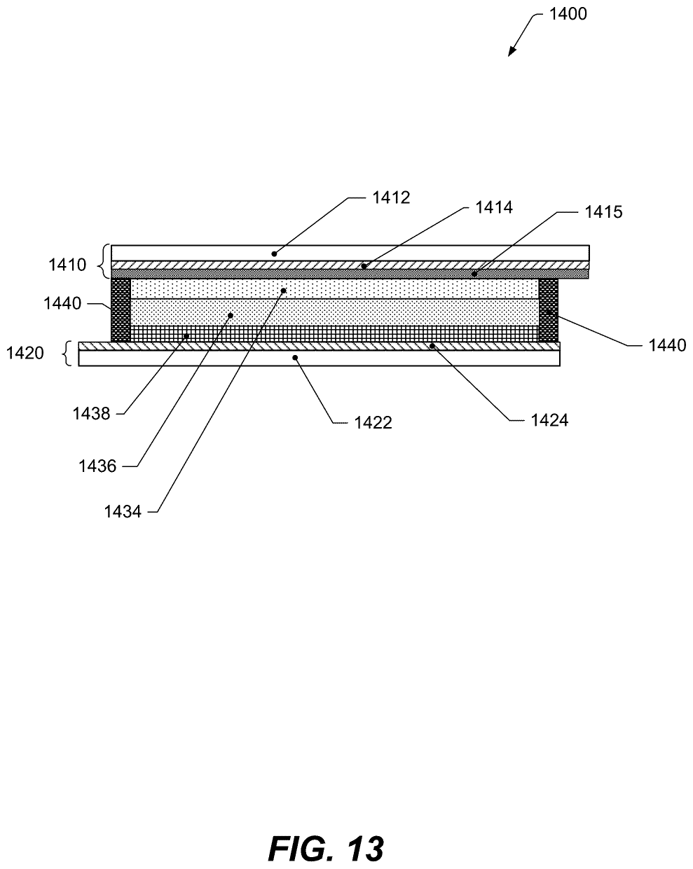

FIG. 13 is a schematic diagram illustrating the general architecture of a dye-sensitized photovoltaic cell 1400 according to an implementation. Dye-sensitized photovoltaic cell 1400 includes three layers disposed between an anode-side assembly 1420 and a cathode-side assembly 1410 with a sealant 1440 surrounding the three layers. Cathode-side assembly 1410 includes a transparent substrate 1412 coated with a first flexible/rigid conductor layer 1414 (e.g., a transparent conducting oxide (TCO) layer), and a catalyst layer 1415. Anode-side assembly 1420 includes a transparent substrate 1422 (e.g., glass sheet) coated with a second flexible/rigid conductor layer 1424 (e.g., a transparent conducting oxide (TCO) layer), The three layers disposed between the anode-side assembly 1420 and cathode-side assembly 1410 include an electrolyte layer 1434, a porous dye-sensitized titanium dioxide film 1436 and a non-porous hole blocking layer 1438. The electrolyte layer 1434 may be, for example, a copper redux electrolyte.

The redox couple may include organocopper (I) and organocopper (II) salts in some cases. Suitable organocopper salts include copper complexes comprising bi- and polydentate organic ligands with counterions. Suitable bidentate organic ligands include, but are not limited to, 6,6′-dialkyl-2,2′-bipyridine: 4,4′,6,6′-tetralkyl-2,2′-bipyridine: 2,9-dialkyl-1,10-phenathroline: 1, 10-phenathroine; and 2,2′-bipyridine. Suitable counterions include, but are not limited to, bis(trifluorosulfon)imide, hexafluorophosphate, and tetrafluoroborate. The ratio of organocopper(I) to organocopper(II) salts may be from about 4:1 to about 12:1. Alternatively, the ratio of organocopper(i) to organocopper(II) salts may be from about 6:1 to about 10:1. In some implementations, the redox couple may include copper complexes with more than one ligand. For example, the redox couple may include a copper (I) complex with 6,6′-dialkyl-2,2′-bipyridine and a copper (II) complex with a bidentate organic ligand selected from the group consisting of 6,6′-dialkyl-2,2′-bipyridine: 4,4′,6,6′-tetralkyl-2,2′-bipyridine; 2,9-dialkyl-1,10-phenathroline: 1, 10-phenathroine; and 2,2′-bipyridine. Alternatively, the redox couple may include a copper (I) complex with 2,9-dialkyl-1,10-phenathroline and a copper (II) complex with a bidentate organic ligand selected from the group consisting of 6,6′-dialkyl-2,2′-bipyridine: 4,4′,6,6′-tetralkyl-2,2′-bipyridine: 2,9-dialkyl-1,10-phenathroline; 1, 10-phenathroine; and 2,2′-bipyridine.

In some embodiments, the electrolyte of a dye-sensitized photovoltaic cell may include two or more solvents. Suitable solvents include, but are not limited to, sulfolane, dialkylsulfone, an alkoxypropionitrile, cyclic carbonates, acyclic carbonates, cyclic lactones, acyclic lactones, low viscosity ionic liquids and binary/tertiary/quaternary mixtures of these solvents. In an exemplary embodiment, the electrolyte includes at least 50% sulfolane or dialkyl sulfone. Alternatively, the electrolyte may include up to about 50% of 3-alkoxypropionitrile, cyclic and acyclic lactones, cyclic and acyclic carbonates, low viscosity ionic liquids, or binary/tertiary/quaternary mixtures thereof. The electrolyte may also include up to about 0.6M N-methylbenzimidazole and up to about 0.2 M lithium bis(trifluorosulfon)imide as additives.

A dye-sensitized photovoltaic cell may include a cathode catalyst disposed on the cathode. A suitable cathode catalyst may include a mixture of 2D conductor and electronic conducting polymer. A “2D conductor” is a molecular semiconductor with thickness in atomic scale. Exemplary 2D conductors include graphenes, transition metal dichalcogenides (ex., molybdenum disulfide or diselenide), or hexagonal boron nitride. For use in embodiments with cathode catalysts, the graphene may include a molecular layer or nano/micro crystal. The graphene may be derived from reduced graphene oxide. Suitable conducting polymers include but are not limited to polythiophene, polypyrrole, polyaniline, and derivatives thereof. An exemplary polythiophene is poly(3,4-ethyelenedioxythiophene) (PEDOT).

In certain embodiments, a dye-sensitized photovoltaic cell includes a cathode, an electrolyte, a porous dye-sensitized titanium dioxide film layer, an anode, and a nonporous hole-blocking layer interposed between the anode and the dye-sensitized titanium dioxide film layer. In one such embodiment, the electrolyte includes a redox couple having organocopper (I) and organocopper (II) salts, and the ratio of organocopper (I) to organocopper (II) salts is from about 4:1 to about 12:1. In another such embodiment, the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents.

In another embodiment, a dye-sensitized photovoltaic cell includes a cathode, and a cathode catalyst disposed on the cathode. In this example, the cathode catalyst includes a 2D conductor and an electronic conducting polymer, an electrolyte, a porous dye-sensitized titanium dioxide film layer, an anode and a nonporous hole-blocking layer interposed between the anode and the dye-sensitized titanium dioxide film layer.

In another embodiment, a dye-sensitized photovoltaic cell includes a cathode, an electrolyte, a porous dye-sensitized titanium dioxide film layer, and an anode. The electrolyte includes a redox couple having organocopper (I) and organocopper (II) salts, and the ratio of organocopper (I) to organocopper (II) salts is from about 4:1 to about 12:1, In this example, the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents.

In certain embodiments, a dye-sensitized photovoltaic cell includes a cathode and a cathode catalyst disposed on the cathode. In one such embodiment, the cathode catalyst includes a 2D conductor and an electronic conducting polymer, an electrolyte, a porous dye-sensitized titanium dioxide film layer, and an anode. The electrolyte includes a redox couple comprising organocopper (I) and organocopper (II) salts, and wherein the ratio of organocopper (I) to organocopper (II) salts is from about 4:1 to about 12:1. In another such embodiment, the cathode catalyst includes a 2D conductor and an electronic conducting polymer, an electrolyte, a porous dye-sensitized titanium dioxide film layer, and an anode. In this example, the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents. In yet another such embodiment, the cathode catalyst includes a 2D conductor and an electronic conducting polymer, an electrolyte, a porous dye-sensitized titanium dioxide film layer, an anode, and a nonporous hole-blocking layer interposed between the anode and the dye-sensitized titanium dioxide film layer. In this example, the electrolyte includes a redox couple comprising organocopper (I) and organocopper (II) salts, and the ratio of organocopper (I) to organocopper (II) salts is from about 4:1 to about 12:1. In yet another such embodiment, the cathode catalyst includes a 2D conductor and an electronic conducting polymer, an electrolyte, a porous dye-sensitized titanium dioxide film layer, an anode, and a nonporous hole-blocking layer interposed between the anode and the dye-sensitized titanium dioxide film layer. In this example, the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents. In yet another such embodiment, the cathode catalyst includes a 2D conductor and an electronic conducting polymer, an electrolyte, a porous dye-sensitized titanium dioxide film layer, and an anode. TIN this example, the electrolyte includes a redox couple comprising organocopper (I) and organocopper (II) salts, and the ratio of organocopper (I) to organocopper (II) salts is from about 4:1 to about 12:1 and the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents. In yet another such embodiment, the cathode catalyst includes a 2D conductor and an electronic conducting polymer, an electrolyte, a porous dye-sensitized titanium dioxide film layer, an anode, and a nonporous hole-blocking layer interposed between the anode and the dye-sensitized titanium dioxide film layer. In this example, the electrolyte includes a redox couple comprising organocopper (I) and organocopper (II) salts, and the ratio of organocopper (I) to organocopper (II) salts is from about 4:1 to about 12:1 and the electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents.

In one embodiment, a dye-sensitized photovoltaic cell includes a cathode, an electrolyte, a porous dye-sensitized titanium dioxide film layer, an anode, and a nonporous hole-blocking layer interposed between the anode and the dye-sensitized titanium dioxide film layer. The electrolyte includes a redox couple comprising organocopper (I) and organocopper (II) salts, and wherein the ratio of organocopper (I) to organocopper (II) salts is from about 4:1 to about 12:1. The electrolyte includes two or more solvents selected from the group consisting of sulfolane, dialkylsulfone, an alkoxypropionitrile, cyclic carbonates, acyclic carbonates, cyclic lactones, acyclic lactones, low viscosity ionic liquids, and binary/tertiary/quaternary mixtures of these solvents.

In some embodiments, the dye-sensitized photovoltaic cells are copper redox based dye-sensitized PV cells having an electrolyte with a copper redox pair. In some such embodiments, the dyes include those described in U.S. Pat. No. 11,286,244 titled “Solar Cell Dyes for Copper Redox Based Dye-sensitized Solar Cells and Combinations Thereof,” incorporated by reference herein for the purpose of describing dyes, and methods of fabrication and examples of materials for a dye-sensitized photovoltaic cell.

A method of producing a photovoltaic cell may include the step of polymerizing PEDOT on the cathode from monomeric EDOT. The PEDOT may be polymerized on the cathode by chemical polymerization or electrochemical polymerization. The PEDOT may be polymerized on the cathode using ferric tosylate or ferric chloride as a catalyst. The ratio of EDOT to ferric chloride may be from about 1:3 to about 1:4. In one embodiment, EDOT is mixed with graphene before chemical polymerization. The EDOT/graphene/ferric catalysis may be deposited from n-butanol on the cathode using spin, gravure, blade or slot coating techniques and allowed to polymerize on the substrate.

A method of forming composite catalytic layers on the cathode of a dye-sensitized photovoltaic cell may include the step of forming a composite graphene material with one or more conducting polymers. Suitable conducting polymers include, but are not limited to, polythiophenes, polypyrroles, and polyanilines. The ratio of graphene to conducting polymer may be from about 0.5:10 to about 2:10. A suitable polythiophene for use in this method is PEDOT. In one alternative embodiment of the method, the polymer and graphenes are polymerized prior to deposition on the cathode. The composite may be formed by the steps of depositing graphene on an electrode to form a graphene layer; and electrodepositing the polymer on the graphene layer.

### Bifacial Photovoltaic Cells

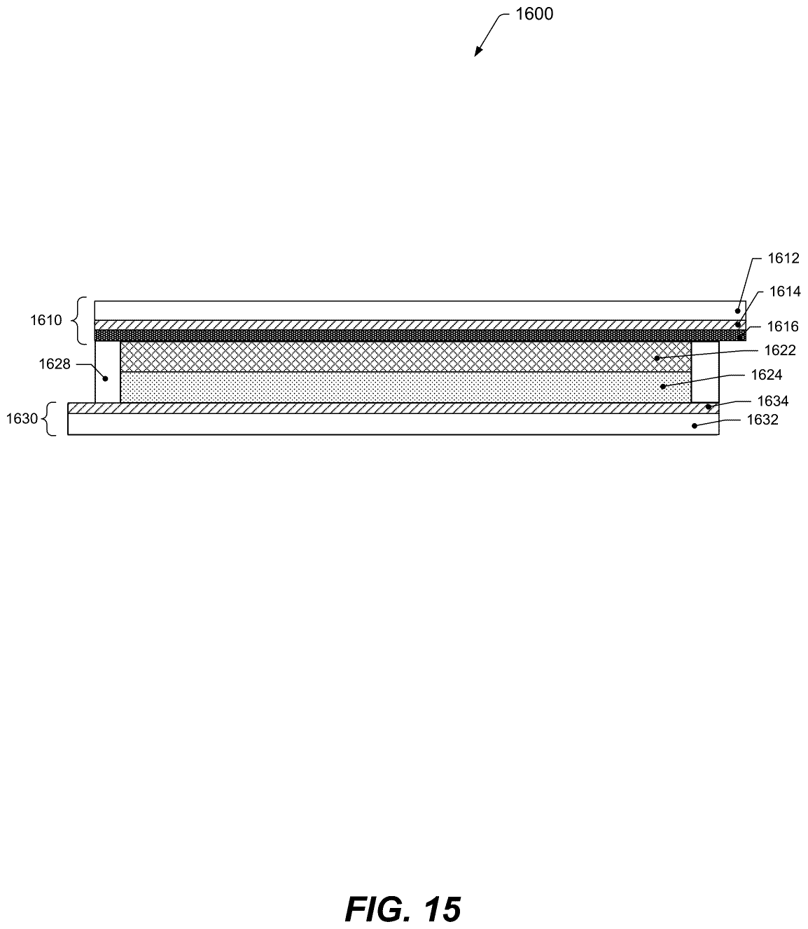

In some embodiments, a mechanical user interface includes one or more bifacial photovoltaic cells. For example, D-pad 702 shown in FIGS. 7-9 includes a bifacial photovoltaic element 712 that may have one or more bifacial photovoltaic cells. A bifacial photovoltaic cell allows for harvesting of photons from either side of the cell. For example, a bifacial photovoltaic cell may allow for harvesting of photons from both the anode-side and the cathode-side of the cell such as with the bifacial photovoltaic cells 1500 and 1600 described in FIGS. 15 and 16. In another example, a bifacial photovoltaic cell may be two monofacial photovoltaic cells such as the photovoltaic cell 1400 shown in FIG. 13 placed back to back to allow for harvesting of photons from one side of each of the back to back cells.

In some cases, bifacial photovoltaic cells may be dye-sensitized photovoltaic cells. For example, the bifacial photovoltaic cells may be dye-sensitized photovoltaic cells that include a layer with a mixture of two sets of particles: small dye-sensitized particles and large particles. The small dye-sensitized particles are smaller than the wavelength and so are transparent to it. The dye absorbs lights and initiates a rapid electron transfer. The large particles are larger than the wavelength of light. Because the large particles are in a matrix of small dye-sensitized particles, they act as micro-reflectors, allowing light to scatter and eventually be harvested. While not necessary for operation, the large particles may be dye-sensitized, allowing for ease of fabrication. The presence of the light-absorbing layer that includes a mixture of small and large particles as described above allows light from both sides of the cell to be absorbed. A light-absorbing layer including both small, dye-sensitized particles and large particles may be incorporated into any dye-sensitized photovoltaic cell.

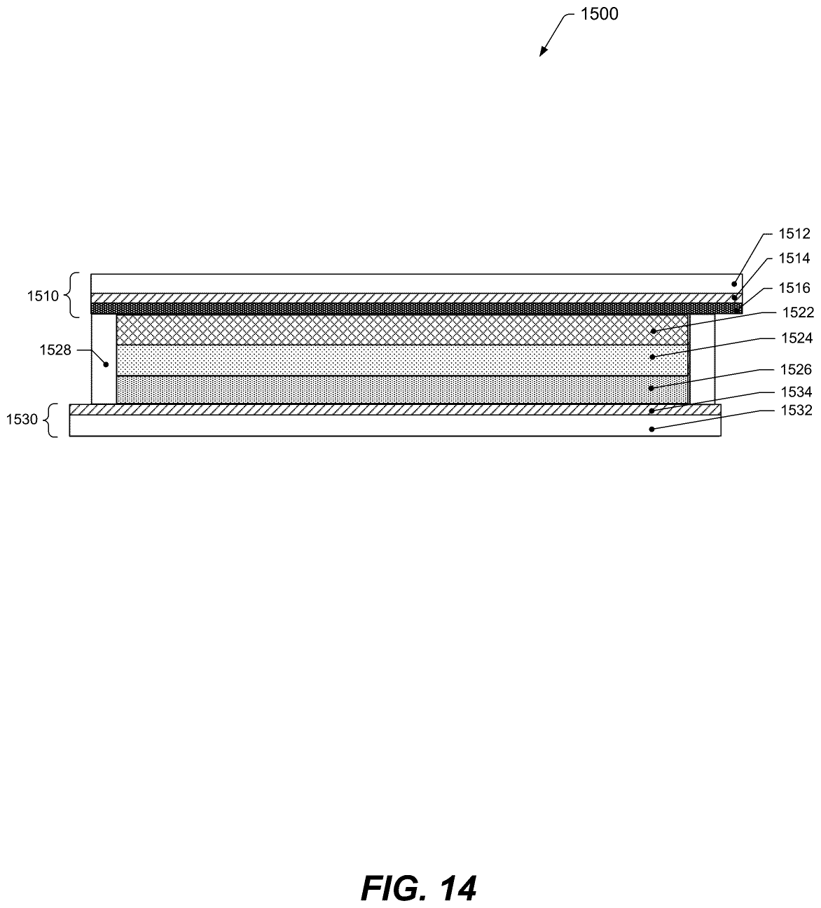

FIG. 14 depicts a cross section of an example of a bifacial photovoltaic cell 1500. Bifacial photovoltaic cell 1500 includes three layers disposed between an anode-side assembly 1530 (anode) and a cathode-side assembly 1510 (cathode), A sealant 1528 surrounds the three layers. Cathode-side assembly 1510 includes a transparent substrate 1512 coated with a transparent conducting oxide (TCO) 1514, and a catalyst layer 1516. Anode-side assembly 1530 includes a transparent substrate 1532 coated with a TCO 1534. Disposed between the cathode-side assembly 1510 and anode-side assembly 1530 are an electrolyte layer 1522, a first light-absorbing layer 1524, and a second light-absorbing layer 1526. The first light-absorbing layer 1524 contains a mixture of small dye-sensitized particles and large particles as described above. The second light-absorbing layer 1526 contains small dye-sensitized particles without large particles. Most photons incoming through the anode are absorbed in the second light-absorbing layer 1526, with photons that pass through the second light-absorbing layer reflected by and/or absorbed in the first light-absorbing layer 1524. The first light-absorbing layer 1524 allows light from the cathode to be harvested.

In the example of FIG. 14, the second light-absorbing layer 1526 is disposed between the anode-side assembly 1530 and the first light-absorbing layer 1524, such that the first light-absorbing layer 1524 is closer to the cathode-side assembly 1510. In alternate embodiments, the first light-absorbing layer 1524 may be disposed between the anode-side assembly 1530 and the second light-absorbing layer 1526, such that the first light-absorbing layer 1524 is closer to the cathode-side assembly 1510.

FIG. 15 depicts a cross section of an alternate embodiment of a bifacial photovoltaic cell 1600. In the example shown in FIG. 15, the layers between the cathode-side assembly 1610 and the anode-side assembly 1630 include an electrolyte layer 1622 and a first light-absorbing layer 1624. The first light-absorbing layer 1624 contains a mixture of small dye-sensitized particles and large particles as described above. Because the large particles are in a matrix of small dye-sensitized particles, they act as micro-reflectors, allowing light to scatter and eventually be harvested by the smaller particles.

Various modifications may be made to the example bifacial photovoltaic cells shown in FIGS. 14 and 15, including modifications to the anode and/or cathode assemblies. For example, a non-porous hole-blocking layer as described in U.S. Patent Publication 2020/0395492, titled “Dye-sensitized photovoltaic cells,” may be used. This publication is incorporated by reference herein for the purpose of describing a dye-sensitized photovoltaic cell architecture, related methods of fabrication, and examples of materials for a dye-sensitized photovoltaic cell.

The bifacial PV cells may be characterized by a comparison of photovoltaic performance from cathode-side illumination and anode-side illumination. According to various embodiments, one or more of the following characteristics may be exhibited. The power density (mW/cm₂) resulting from cathode-side illumination may be at least 30%, 40%, 50%, 60%, or 70% of the power density resulting from anode-side illumination. Short circuit current density (Jsc, mA/cm₂) resulting from cathode-side illumination may be at least 30%, 40%, 50%, 60%, or 70% of the short circuit current density resulting from anode-side illumination.

The first light-absorbing layers 1524 and 1624 in bifacial photovoltaic cells 1500 and 1600 shown in FIGS. 15 and 16 may also be referred to as a light-scattering layer, a light-absorbing-and-scattering layer, or a mixed particle layer. As indicated above, these first light-absorbing layers 1524 and 1624 include a mixture of small and large particles. According to various embodiments, a distribution of small particles in a light-absorbing layer may be characterized by having an average size between 10 nm and 50 nm. A distribution of a large particles in a light-absorbing layer may be characterized by having an average size between 100 nm and 500 nm. The particles are generally nominally spherical, with size referring to diameter. Particles of other shapes may be used. In such cases, size refers to the largest linear dimension.

In a mixed particle layer, the large particles may be thought of as distributed in a matrix of small particles. The large particles are generally distributed throughout the layer, though the distribution is not necessarily precisely controlled, with some randomness. As described further below in the examples, the mixed particle layer may be prepared using an aqueous dispersion of particles and a polymer binder. According to various embodiments, fewer than half of the total number of particles are large particles. In some embodiments, between about 5% and 40% or 5% and 20% of the total number of particles are large particles, with all or substantially all (e.g., greater than 90% or 99%) of the remainder being small particles.

The large particles may be semiconducting or dielectric particles. In some embodiments, they are metal oxides with example materials including TiO₂, ZnO₂, SiO₂, SnO₂, Ta₂O₅, and polymeric nanomaterials. The small particles are dye-sensitized metal oxide particles. Examples include titanium dioxide (TiO₂), zinc dioxide (ZnO₂), tin dioxide (SnO₂), and tantalum pentoxide (Ta₂O₅), Examples of dyes and fabrication techniques are given below.

As discussed above, in some embodiments, the mixed particle layer is one layer of a bilayer. An example is shown in FIG. 14 in which there are two light-absorbing layers, one with and one without large particles, the layers may be of approximately the same thickness, e.g., 2 to 12 nm or 4 to 10 nm thick each. In alternate embodiments, one layer may be thicker than the other.

It will be apparent that certain changes and modifications may be practiced within the scope of the disclosure. For example, in certain embodiments, the user interface may include any appropriate number of buttons or other user interface features. In certain embodiments, the user interface may be configured for force sensing and/or gesture detection. Accordingly, the present embodiments are to be considered as illustrative and not restrictive, and the invention is not to be limited to the details given herein.

Modifications, additions, or omissions may be made to any of the above-described implementations without departing from the scope of the disclosure. Any of the implementations described above may include more, fewer, or other features without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

What is claimed is:

1. An electronic device comprising:
a device housing having a front side;
a photovoltaic cell housed within the device housing, the photovoltaic cell configured to receive ambient light and generate electric power to power the electronic device; and
a translucent user interface (UI) component provided at the front side of the device housing, the translucent UI component configured to accept user input to the electronic device via physical contact with the translucent UI component and configured to transmit ambient light to the photovoltaic cell.

2. The electronic device of claim 1, wherein the device housing comprises a bezel surrounding the translucent UI component.

3. The electronic device of claim 1, wherein the user input comprises a pressure load applied to the translucent UI component.

4. The electronic device of claim 1, wherein the translucent UI component is part of a directional pad.

5. The electronic device of claim 1, further comprising one or more pressure redistribution elements configured to redistribute a pressure load away from the photovoltaic cell.

6. An electronic device comprising:
a housing having a frontside and a backside;
a photovoltaic element within the housing; and
a translucent user interface (UI) component at the front side of the housing, the translucent user UI component configured to receive a first pressure and to pass ambient light from an exterior environment to a first light facing surface of the photovoltaic element.

7. The electronic device of claim 6, wherein the translucent UI component comprises an outer surface configured to accept the first pressure.

8. The electronic device of claim 6, further comprising one or more pressure redistribution elements configured to substantially redistribute the first pressure away from the photovoltaic element and transfer at least a portion of the first pressure to at least one switch of a plurality of switches.

9. The electronic device of claim 6, further comprising a bezel surrounding the translucent UI component, wherein the bezel is configured to accept a second pressure.

10. The electronic device of claim 9, further comprising one or more pressure redistribution elements configured to substantially redistribute the first pressure and/or the second pressure away from the photovoltaic element and transfer at least a portion of the first pressure and/or the second pressure to at least one switch of a plurality of switches.

11. The electronic device of claim 10, wherein the one or more pressure redistribution elements comprise a flexible gasket in contact with the plurality of switches, the flexible gasket configured to receive the first pressure and/or the second pressure and transfer at least a portion of the first pressure and/or the second pressure to the at least one switch of the plurality of switches.

12. The electronic device of claim 11, wherein the one or more pressure redistribution elements further comprise:
one or more posts in contact with the translucent UI component to receive the first pressure;
a backplate in contact with the one or more posts to receive the first pressure; and
wherein the flexible gasket is in contact with the backplate to receive the first pressure from the backplate and transfer the at least the portion of the first pressure to a center switch of the plurality of switches.

13. The electronic device of claim 12, wherein the photovoltaic element is between the translucent UI component and the backplate.

14. The electronic device of claim 13, further comprising one or more foam layers between the photovoltaic element and the translucent UI component and/or between the photovoltaic element and the backplate.

15. The electronic device of claim 10, wherein the plurality of switches comprises a center switch and a plurality of directional switches.

16. The electronic device of claim 15, wherein the plurality of directional switches comprises four (4) directional switches at cardinal positions or two (2) directional switches.

17. The electronic device of claim 6, wherein the translucent UI component is part of a directional pad.

18. The electronic device of claim 6, wherein the photovoltaic element comprises at least one dye-sensitized photovoltaic cell and/or at least one.

19. The electronic device of claim 6, wherein the photovoltaic element comprises at least one bifacial photovoltaic cell.

20. The electronic device of claim 19, wherein the backside of the housing includes a translucent window configured to pass ambient light received from the exterior environment.

21. The electronic device of claim 20, further comprising one or more pressure redistribution elements configured to substantially redistribute the first pressure away from the photovoltaic element and transfer at least a portion of the first pressure to an offset center switch.

22. The electronic device of claim 21, wherein the offset center switch is mounted on a circuit board between the photovoltaic element and an outer wall in the backside of the housing, the circuit board comprising a cutout configured to pass ambient light received through the translucent window to a second light facing surface of the photovoltaic element.

23. The electronic device of claim 21, wherein the one or more pressure redistribution elements comprises at least one arm configured to transfer the first pressure to the offset center switch.

24. The electronic device of claim 21, further comprising a bezel surrounding the translucent UI component, wherein the bezel is configured to accept a second pressure.

25. The electronic device of claim 24, wherein the one or more pressure redistribution elements are further configured to transfer at least a portion of the second pressure to at least one directional switch.

26. An energy harvesting system comprising:
a photovoltaic element configured to generate energy from ambient light received through a translucent user interface component in an electronic device;
one or more energy storage elements;
a power management controller configured to receive energy generated by the photovoltaic element and store energy to the one or more energy storage elements; and
a load system configured to receive energy from the power management controller and use the energy to perform one or more functions of the electronic device.
